(19) United States
(12) Patent Application Publication
(10) Pub. No.: US 2014/0217841 A1
(43) Pub. Date: Aug. 7, 2014

(54) HIGH EFFICIENCY, LOW COOLANT FLOW ELECTRIC MOTOR COOLANT SYSTEM

(71) Applicant: Brammo, Inc., Ashland, OR (US)

(72) Inventor: Daniel M. Riegels, Ashland, OR (US)

(73) Assignee: BRAMMO, INC., Ashland, OR (US)

(21) Appl. No.: 14/089,187

(22) Filed: Nov. 25, 2013

Related U.S. Application Data
(60) Provisional application No. 61/737,447, filed on Dec. 14, 2012.

(51) Int. Cl. H02K 9/19

(52) U.S. Cl. CPC H02K 9/19
USPC 310/54

(57) ABSTRACT

A fluid-cooled electric motor includes a generally tubular-shaped motor housing having a plurality of channels through which a coolant can flow. The channels are spaced apart from each other in an annular arrangement around the housing and extend through the housing in an axial direction. Each of the channels is surrounded by a portion of the housing defining walls of the channel forming a cooling surface area.

### CROSS REFERENCE TO RELATED APPLICATION

This application claims priority from U.S. Provisional Patent Application No. 61/737,447 filed on Dec. 14, 2012 entitled HIGH EFFICIENCY, LOW COOLANT FLOW ELECTRIC MOTOR COOLANT SYSTEM, which is hereby incorporated by reference.

### BACKGROUND

The present application relates to thermal management of electric motors and, more particularly, to coolant systems for removing excess heat from electric motors with increased efficiency, greater reliability, and at reduced cost.

Electric motors have a wide variety of applications as generators and motors. For example, as generators, they can act as regeneration systems within the driveline of a vehicle, and generate power for vehicle ancillaries (similar to an alternator). As motors, they can drive the wheels of a vehicle and ancillary subsystems such as pumps, linkages, motion controls, and fans.

Although electric motors have much higher efficiency than motors that run on fuel such as gasoline or diesel, excess heat is nevertheless produced as a byproduct and must be transferred away from the motor itself. If too much heat is generated, an electric motor can be damaged by shorting of internal electrical wires and/or demagnetization of the motor's magnets.

There are generally two techniques for dissipating heat from electric motors. The first involves using air flow over the motor to conduct heat away from the motor. This is the simplest approach, but has low efficiency with removing heat and may not work with large heat transfers. The second technique involves using a liquid coolant (often water) to transfer the heat. The heated water is then typically run through a radiator to force cooling with the surrounding air. The cooled water is returned to the motor to provide continuous cooling.

There are many variations of the above two methods to increase efficiency of heat transfer from the motor. As an example, for air cooling, increasing the effective surface of the motor by adding heat fins can help improve the heat transfer. Increasing the air flow over the motor (e.g., by using a fan) can also increase heat removal. For water-cooled motors, similar techniques can also be employed. The water flow can be increased for additional cooling, but at the cost of using a larger water pump. Increasing the surface area that the water comes into contact with the motor can also provide additional cooling.

Typical water-cooled motors have a water-tight sleeve around the motor itself. The sleeve forms a seal that keeps the liquid coolant next to the motor, and has an inlet (to pump the water into the sleeve), and an outlet (to transfer the heated water to the radiator). In general, the inlet and outlet are on opposite sides of the motor, so the water flows over the entire surface of the motor to improve heat transfer.

### BRIEF SUMMARY OF THE DISCLOSURE

A fluid-cooled electric motor in accordance with one or more embodiments comprises a rotor, a stator surrounding the rotor, and a generally tubular-shaped housing surrounding the stator. The housing includes a plurality of channels through which a coolant can flow. The channels are spaced apart from each other in an annular arrangement around the housing and extend through the housing in an axial direction. Each of the channels is surrounded by a portion of the housing defining walls of the channel forming a cooling surface area.

A method of cooling an electric motor in accordance with one or more embodiments comprises: providing an electric motor comprising a rotor, a stator surrounding the rotor, and a generally tubular-shaped housing surrounding the stator, said housing including a plurality of channels spaced apart from each other in an annular arrangement around the housing and extending through the housing in an axial direction, each of said channels being surrounded by a portion of the housing defining walls of the channel forming a cooling surface area; and flowing a coolant through each of said channels to cool the electric motor.

### BRIEF DESCRIPTION OF THE DRAWINGS

FIG. 1 is a cross-section view of an electric motor having a coolant system in accordance with the prior art.

FIG. 2 is a perspective view of an exemplary electric motor having coolant system in accordance with one or more embodiments.

FIG. 3 is a perspective view of the rotor/stator assembly in the electric motor of FIG. 2.

FIG. 4 is a perspective view of the housing of the electric motor of FIG. 2 in accordance with one or more embodiments.

FIG. 5 is a cross-section view of the extruded metal housing of the electric motor shown in FIG. 2 in accordance with one or more embodiments.

FIG. 6 is a cross-section view similar to FIG. 5 showing heat transfer through the extruded metal housing in accordance with one or more embodiments.

FIG. 7 is a simplified perspective view of an electric motor housing showing coolant flow from channel to channel in accordance with one or more embodiments.

FIG. 8 is an exploded view showing a front end-cap and diverter plate of the motor housing in accordance with one or more embodiments.

FIG. 9 is an exploded view showing a rear end-cap and diverter plate of the motor housing in accordance with one or more embodiments.

FIG. 10 is a cross-section view of an electric motor housing with radially spaced channels in accordance with one or more embodiments.

FIG. 11 is a cross-section view of an electric motor housing showing channels with features to increase cooling surface area in accordance with one or more embodiments.

### DETAILED DESCRIPTION

Various embodiments disclosed herein are directed to a coolant system for an electric motor. The coolant system efficiently removes heat from the electric motor by providing a unique path for liquid coolant to flow through extruded channels in the motor's outer shell or housing. The channels are connected in a way that exposes a greater surface area that coolant is in contact with. Consequently, there is an increased rate of heat removal per unit motor volume. Additionally, the coolant channels are designed to provide minimal flow restriction, thus maximizing flow rates and cooling performance.

In addition, the coolant system simplifies manufacturing because the coolant channels are integral with the motor housing or casing, which comprises a single part that can be made of extruded metal. The extruded motor housing contains only a small number of internal cavities, which improves “extrudability”, while generally maximizing the cooling surface area of the channels. (The internal cavities comprise the cooling channels and the bore. The bore supports the motor stator and the endplates, which support the motor and the rotating rotor.) The design is scalable to generally any motor length by simply cutting the extrusion to the required length. All other components simply attach to the extrusion in the same or similar way, resulting in a cooling system that is highly and easily configurable.

As discussed below, heat extraction from an electric motor depends on several factors including the available surface area on the motor surface to conduct the heat transfer, the temperature of the liquid coolant flowing on the surface of the motor, and the flowrate of the coolant. Other factors such as the thermal conductivities for all materials used are also important, but not addressed as they are considered constants when comparing with other heat extraction methods.

Various types of coolant can be used in the coolant system including, e.g., water, oil, aqueous coolant mixtures (ethylene or propylene glycol +distilled water), and phase change coolants.

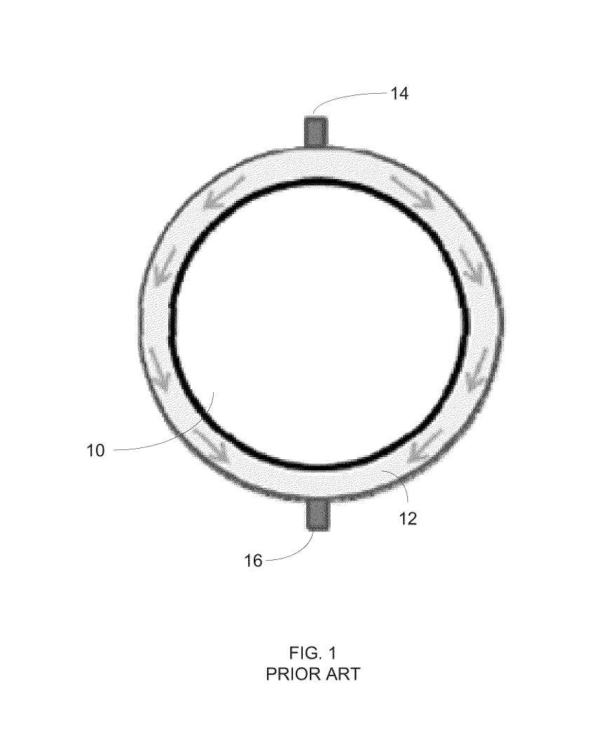

FIG. 1 is a cross-section view of a typical water-cooled electric motor 10 in accordance with the prior art. A water-tight sleeve 12 surrounds the motor 10. The sleeve 12 forms a seal that keeps the liquid coolant next to the motor, and has an inlet 14 (to pump the water into the sleeve), and an outlet 16 (which sends the heated water to a radiator or other heat exchanger). Water enters from the inlet 14 and runs through the coolant sleeve 12 on both sides of the motor 10. During this time, heat exchange takes place where the water absorbs heat from the motor 10. The water takes a circumferential path around the motor, and then exits through outlet 16 at the opposite side of the sleeve 12.

As the water flows within the water-cooled sleeve 12, the cross-sectional area in which the water is allowed to flow varies greatly. It is at its smallest within the inlet hose 14, then transitions to a much larger area once entering the cooling jacket 12. Because the water is incompressible and the total flowrate through the motor is unchanged, the water has reduced velocity when flowing within the jacket 12. It is a well understood effect of nature that convective cooling performance diminishes as flow velocity decreases. Convection performance is at a minimum when the flow is laminar (non-mixing stream lines), and increases as turbulence starts to occur as the flow speeds up (mixing streamlines).

In the design shown in FIG. 1, it is difficult to maintain non-laminar (turbulent) flow conditions due to the slowing of the flow velocity, and convective cooling performance is accordingly typically poor.

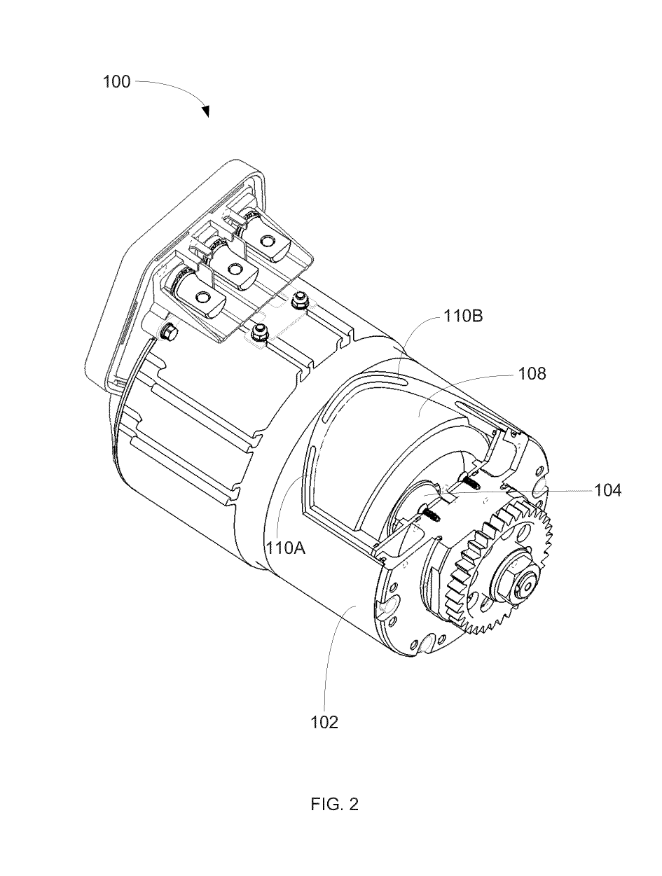

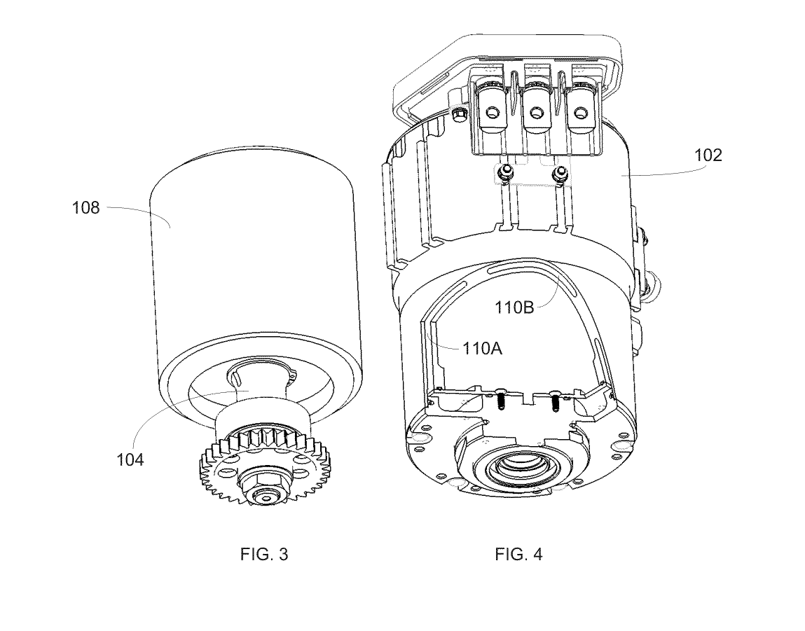

FIG. 2 shows an exemplary electric motor 100 in accordance with one or more embodiments. The motor 100 includes a motor housing 102, which surrounds a stator 108 and rotor 104. FIGS. 3 and 4 separately show the stator/rotor assembly and the motor housing 102, respectively. In FIGS. 2 and 4, a portion of the motor housing has been cut away to illustrate channels formed therein.

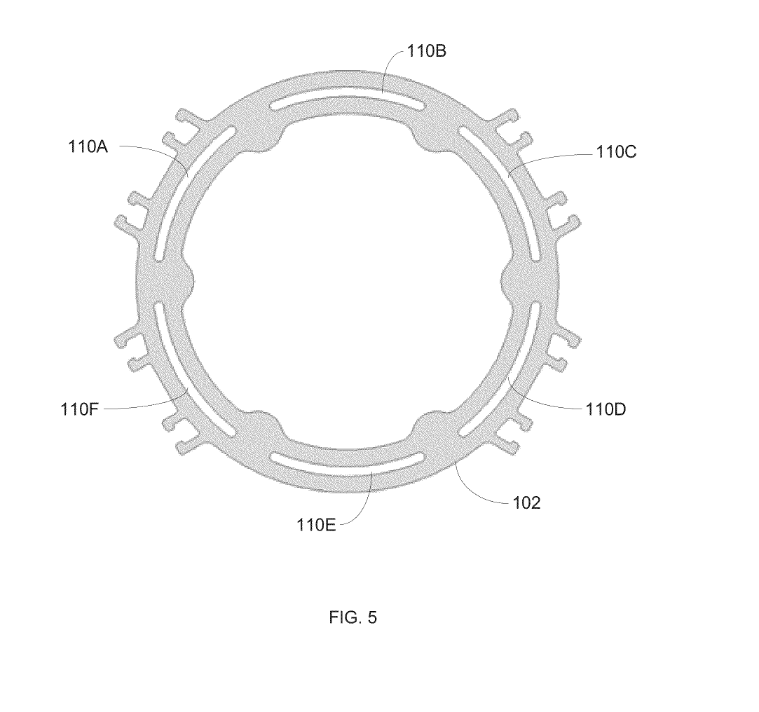

In accordance with one or more embodiments, the motor housing 102 is made from a single piece of extruded metal. By way of example, the extrusion can be made from aluminum alloys (6061, 6005A, 6063). A plurality of channels 110A-F are formed within the housing 102 and spaced apart in an annular arrangement around the housing 102 as shown in FIGS. 5-7. The channels 110A-F are designed to carry coolant lengthwise (i.e., axially) along the motor.

Liquid coolant is forced to flow through channels 110A-F, which are connected to each other. The channels 110A-F can be connected in series, in parallel, or in a combination of the two.

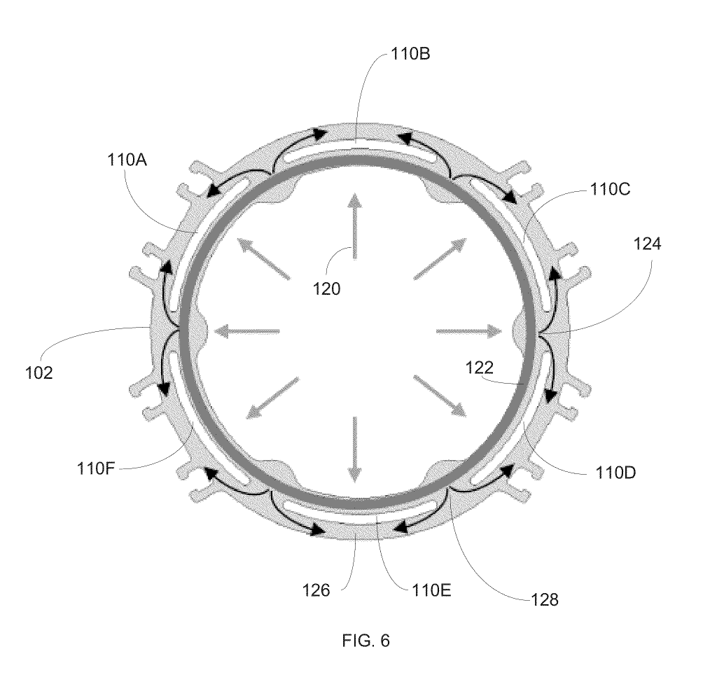

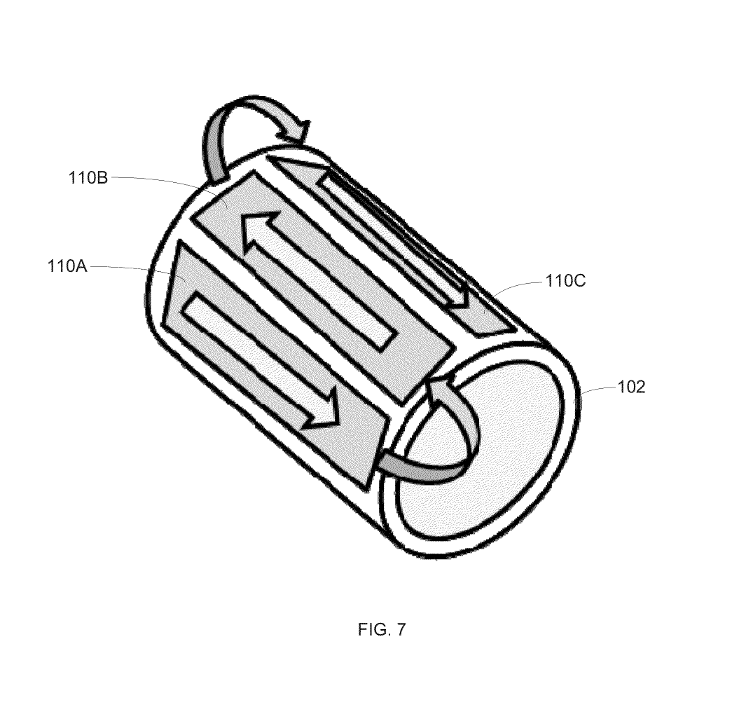

FIG. 6 illustrates how heat is conducted radially from the interior of the motor into the housing 102 (as indicated by arrows 120). Heat is first transferred to the radially inner side 122 of the housing 102, and then is conducted along the walls 124 between the channels 110A-F (as indicated by arrows 128) to the radially outer side 126 of the housing 102. As metal is an excellent heat conductor, both the inside 122 and outside 126 of the motor housing 102 will be heated. Because the channels 110A-F are surrounded by portions of the housing 102, the heat transfer surface area around the coolant is significantly increased. Accordingly, regardless of whether the flow through the channels 110A-F is in series or in parallel, the convective cooling performance of the motor housing 102 is significantly improved because of the increased heat transfer surface area provided by the channels 110A-F.

By contrast, in common coolant-cooled electric motors as shown in FIG. 1, cooling is accomplished by using a sleeve 12 that encapsulates the motor and allows coolant to flow around the motor from one side to the other. Heat transfer takes place only on the inner (i.e., motor side) of the sleeve 12; the opposite outer side of the sleeve 12 is used for retaining the coolant next to the motor, but is not connected to the motor itself. Accordingly, very little or no heat transfer is contributed by the outer side of the coolant sleeve 12.

The exemplary motor housing 102 illustrated in FIG. 5 contains six channels 110A-F. It should be understood that the number of channels can be varied depending on particular applications.

FIG. 7 schematically shows how the coolant flows from one channel to the next when the channels 110A-F are connected in series. For purposes of illustration, only the first three channels are shown in FIG. 7. Coolant is received by the motor through an inlet. The coolant enters the first channel 110A and flows lengthwise across the motor to the opposite end, where it is re-directed into the adjacent channel 110B where it now flows in the opposite direction across the length of the motor. When the coolant reaches the end of channel 110B, it is re-directed into the next channel 110C where it flows lengthwise along the motor, and is then redirected into the next channel 110D (not shown in FIG. 7). This process continues until all the channels 110A-F are used, and then the coolant exits through an outlet and is sent to a heat-exchanger such as a radiator.

By connecting the channels 110A-F in series, a higher flow velocity is achieved (with increased flow restriction), resulting in improved convective cooling performance. If the channels are connected in parallel (not shown), there is decreased flow restriction resulting in decreased flow velocity, which thereby reduces convective cooling performance.

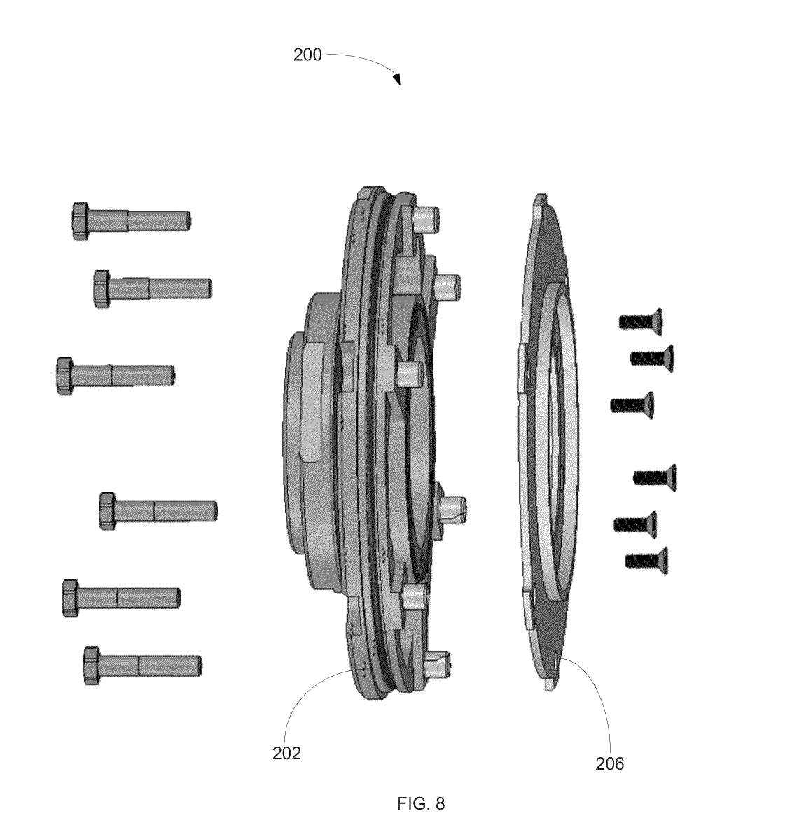

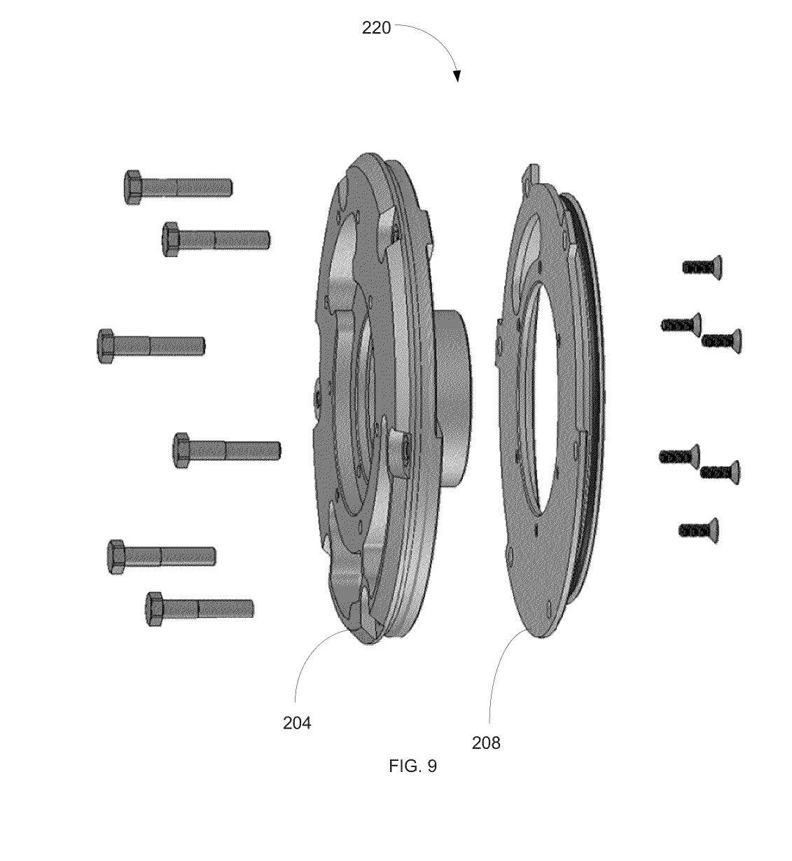

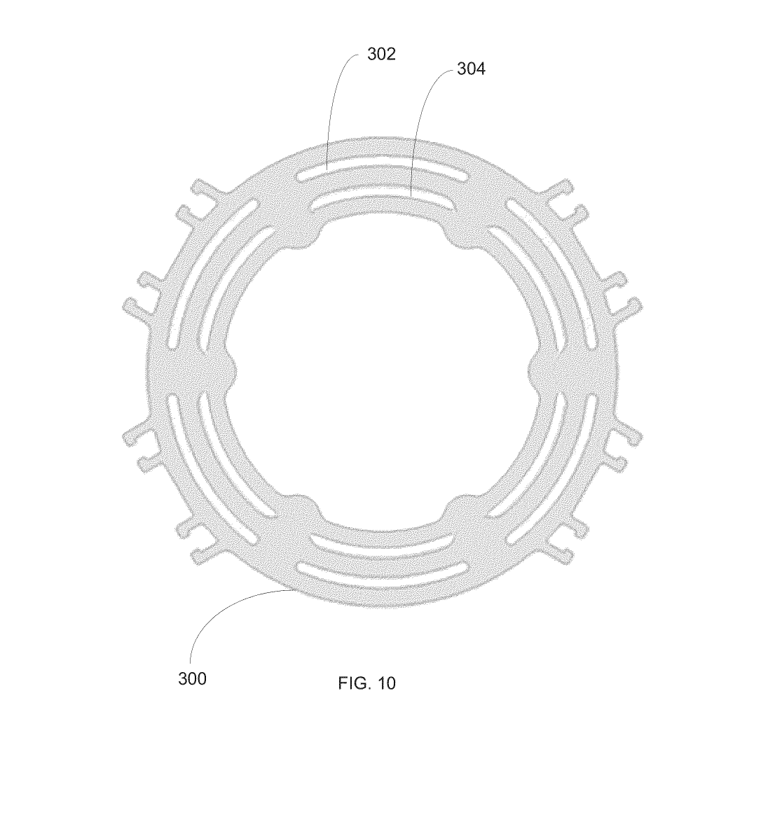

The routing of coolant from one channel to the next is performed by the end-cap assemblies 200 and 220 shown in FIGS. 8 and 9, respectively, which are provided at opposite ends of the motor housing 102. Each end-cap assembly 200, 220 comprises a single cast end-cap 202, 204 and a single flat diverter plate 206, 208, respectively. Each end-cap 202, 204 is bolted to a flat diverter plate 206, 208, and then the assemblies are each bolted to one end of the motor. The parts are sealed using gasketing sealant. By simply bolting each end-cap to each end, adjacent cooling channels in the housing 102 can be connected either in series or parallel while also supplying structural mounts for the rotor and wiring. Different end-cap configurations are needed for series or parallel coolant routing. The end-cap assemblies comprise relatively simple mechanisms with few parts for coolant routing.

If the motor is required to be longer or shorter (e.g., to obtain more or less power, respectively), the housing extrusion can be cut longer or shorter as needed. The endplate assemblies and mechanism of connecting adjacent channels and sealing remain unchanged.

FIG. 10 shows an alternate configuration of the housing extrusion 300 with two sets of channels 302, 304 that are radially spaced apart. This structure results in additional coolant distribution within the housing and increased cooling power as a result of the increased heat transfer surface area provided by the additional channels in the housing. This design is also achievable using the integrated channel extrusion design shown in other exemplary embodiments disclosed herein.

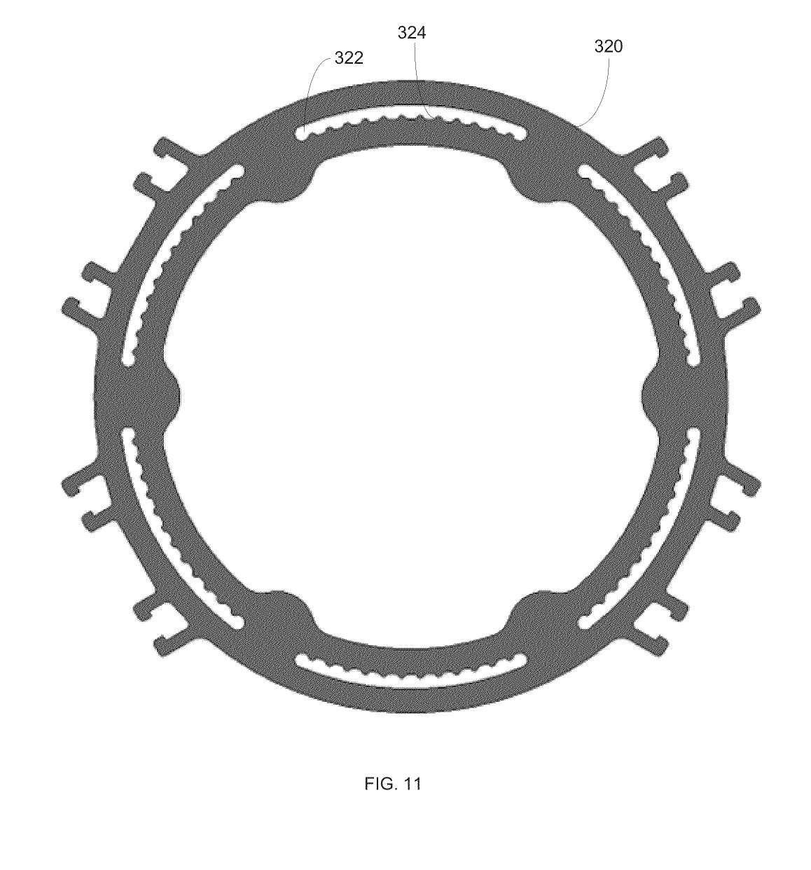

FIG. 11 shows another alternative configuration of the housing extrusion 320. In this embodiment, the channels 322 each include internal ribs 324 on the inside channel wall. The ribs 324 increase the channel surface area, thereby increasing the rate of heat transfer to the coolant. The ribs 324 can be provided on the radially inner side of the channel (as shown in FIG. 11), the opposite side, or on both sides to further increase the channel surface area. The ribs increase the surface area presented to the coolant, thus increasing the total heat transfer.

The electric motor coolant system in accordance with various embodiments has several advantages. The system can be easily manufactured and assembled. The motor housing can be extruded as a single piece. The coolant channels do not have to be cut or attached to the motor, as the channels are integrally formed within the motor housing during extrusion.

In addition, changing the length of motor (to increase or decrease output power) requires the modification of only one part to adjust length of the motor housing.

The system also has less complexity and is less likely to leak as a result since the main portion of the cooling system is contained within a single piece of extruded metal. Because fewer parts are used in the assembly, the chances of leakage due to part failure is reduced.

The system provides higher efficiency in heat extraction. The surface area that the coolant comes in contact with is increased. The greater the surface area available for contact with a liquid coolant, the quicker and more efficient the heat removal becomes.

Lower flows for liquid cooling can be used, which allows for use of smaller pumps, reduced energy usage in pumping the coolant, and a simplified mechanical design.

Furthermore, because the cooling system is an integral structural part of the motor, a more reliable and robust design is possible as it comprises a single piece. It is less likely to be leak, break, or crack as a result of thermal stress, usage over time, or an accidental puncture.

The system can be made at a lower cost due to its reduced design complexity and part count. Parts can be manufactured using high volume manufacturing methods, and require minimal machining.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

What is claimed is:

1. A fluid-cooled electric motor, comprising:
a rotor;
a stator surrounding the rotor; and
a generally tubular-shaped housing surrounding the stator, said housing including a plurality of channels through which a coolant can flow, said channels being spaced apart from each other in an annular arrangement around the housing and extending through the housing in an axial direction, each of said channels being surrounded by a portion of the housing defining walls of the channel forming a cooling surface area.

2. The fluid-cooled electric motor of claim 1, wherein the housing comprises a single piece of extruded metal.

3. The fluid-cooled electric motor of claim 1, wherein the housing comprises an aluminum alloy.

4. The fluid-cooled electric motor of claim 1, wherein the channels are connected in series, parallel, or a combination thereof.

5. The fluid-cooled electric motor of claim 1, wherein the channels are connected in series such that the coolant flows alternatingly from one end of the housing to the other through the channels.

6. The fluid-cooled electric motor of claim 1, wherein the channels are connected in parallel.

7. The fluid-cooled electric motor of claim 1, wherein the housing comprises radially inner and outer portions, and wherein the channels are located between the radially inner and outer portions.

8. The fluid-cooled electric motor of claim 1, wherein the plurality of channels include channels that are radially spaced apart in the housing.

9. The fluid-cooled electric motor of claim 1, wherein one or more walls defining each channel includes features extending into the channel for increasing the heat transfer surface area.

10. The fluid-cooled electric motor of claim 9, wherein the features comprise ribs.

11. The fluid-cooled electric motor of claim 1, further comprising end-caps at opposite ends of the housing for directing flow of the coolant from one channel to an adjacent channel.

12. The fluid-cooled electric motor of claim 1, wherein the fluid-cooled electric motor is configured to be used in an electric vehicle.

13. The fluid-cooled electric motor of claim 1, wherein the cooling fluid comprises water.

14. A method of cooling an electric motor, comprising:
providing an electric motor comprising a rotor, a stator surrounding the rotor, and a generally tubular-shaped housing surrounding the stator, said housing including a plurality of channels spaced apart from each other in an annular arrangement around the housing and extending through the housing in an axial direction, each of said channels being surrounded by a portion of the housing defining walls of the channel forming a cooling surface area; and
flowing a coolant through each of said channels to cool the electric motor.

15. The method of claim 14, wherein the channels are connected in series, and flowing the coolant comprises flowing the coolant alternatingly from one end of the housing to an opposite end through the channels.

16. The method of claim 14, wherein flowing the coolant comprises flowing the coolant through said channels in parallel.

17. The method of claim 14, wherein flowing a coolant comprises providing the coolant at a coolant inlet in the housing, and further comprising receiving heated coolant from the motor at a coolant outlet, transferring the heated coolant to a heat exchanger, and recirculating the coolant through the channels.
